(19) United States
(12) Patent Application Publication
(10) Pub. No.: US 2007/0054664 A1
(43) Pub. Date: Mar. 8, 2007

(54) WIRELESS COMMUNICATION TERMINAL AND METHOD FOR EMERGENCY CALL CONNECTION USING HAND-OFF

(75) Inventor: Tae Hoo KIM, Seoul (KR)

Correspondence Address: H.C. PARK & ASSOCIATES, PLC, 8500 LEESBURG PIKE, SUITE 7500, VIENNA, VA, 22182, US

(73) Assignee: PANTECH & CURITEL COMMUNICATIONS, INC., Seoul (KR)

(21) Appl. No.: 11/468,587

(22) Filed: Aug. 30, 2006

(30) Foreign Application Priority Data
Sep. 1, 2005 (KR) 10-2005-0081376

(51) Int. Cl. H04Q 7/20

(52) U.S. Cl. 455/432.1; 455/435.2

(57) ABSTRACT

The present invention relates to a wireless communication terminal for emergency call connection using hand-off. The communication terminal includes a wireless transceiver unit for transmitting and receiving a message, a storage unit for storing a protocol roaming list; an input unit for receiving a request signal, and a control unit for transmitting a channel allotment request message to a first base station in response to a signal related to transmission of the emergency call received from the input unit. Upon receiving a reorder order message from the first base station, the terminal transmits another channel allotment request message to a second base station stored in the protocol roaming list and having a greater channel allotment possibility.

### CROSS REFERENCE TO RELATED APPLICATION

The present application claims the benefit and priority of Korean Patent Application No. 10-2005-0081376, filed on Sep. 1, 2005, which is hereby incorporated by reference for all purposes as if fully set forth herein.

### BACKGROUND OF THE INVENTION

1. Field of the Invention

The present invention relates to a wireless communication terminal for emergency call connection using hand-off and a method thereof, and more specifically, to a technology of attempting connection to other networks having a greater channel allotment possibility to receive a channel when there is no available traffic channel due to a load generated in a currently connection-tried network in time of transmitting the emergency call, thereby improving transmission success rate of the emergency call.

2. Discussion of the Background

In general, types of wireless communication terminals may include a mobile communication terminal, a personal portable communication terminal (PCS), a smart phone, a next generation mobile communication terminal (IMT-2000), a wireless local-area network (LAN) terminal that is portable and enables the wireless communication.

A wireless communication network may refer to a system including a base station, a base station controller and a wireless exchanger.

An emergency call may refer to a call for urgently allotting a traffic channel, and may include, for example, a fire alarm call or an emergency first-aid call.

A general usage environment of the wireless communication terminal may include a cellular system having a plurality of cells arranged by dividing the whole service area into multiple base station areas to increase the efficiency of frequency bandwidth use and to enable a continuous communication by intensively controlling the multiple base station areas with base station controllers and exchangers even when the wireless terminal travels among the different cells.

In this cellular system, the wireless communication terminal may perform a hand-off function so that a user can communicate without interruption when the wireless communication terminal departs from one base station area and enters another base station area. Here, the base station controllers convert wire/wireless signals so that base stations and exchangers can communicate smoothly, and the exchangers allot and manage the channels of a plurality of base stations and connect different communication networks by interacting with other exchangers.

As mentioned above, the hand-off converts traffic channels automatically so that a user can communicate continuously while moving between cells. Hand-off includes an intra-cell handoff, an inter-cell handoff and an intra-network handoff. The intra-cell hand-off changes traffic channels only in the same cell.

When a call is transmitted with the wireless communication terminal, the network or cellular network that currently performs a connection trial also generates a load, which may prevent prompt call connection.

That is, non availability of a channel that can be allotted as a traffic channel in the cellular network may delay the call connection. Particularly, in case of emergency calls, a small amount of delay of the call connection may cause serious problems.

However, the conventional wireless communication terminal attempts call connections by requesting a channel allotment repeatedly from the corresponding network that is already loaded and cannot allot a traffic channel for emergency calls. This may downgrade the call transmission success rate of emergency calls and may also result in unnecessary battery consumption.

That is, when a reorder order message (or, a message which indicates that the network is busy) is received from the network (or, base station of the network), the conventional wireless communication terminal attempts a call transmission by repeatedly requesting a channel allotment to the same network for predetermined times. This degrades the call transmission success rate of emergency calls and causes unnecessary battery consumption.

### SUMMARY OF THE INVENTION

Various embodiments of the present invention are directed to a wireless communication terminal for emergency call connection using hand-off for moving into the other network (cellular network) having a greater channel allotment possibility from a loaded network (cellular network) no available traffic channel (or, available channels) to receive a channel for emergency calls, to improve call transmission success rate of emergency calls. The present invention also discloses a method for implementing such a device.

Additional features of the invention will be set forth in the description which follows, and in part will be apparent from the description, or may be learned by practice of the invention.

The present invention provides a wireless communication terminal that comprises: a wireless transceiver unit that transmits and receives a message with an external apparatus and a storage unit for storing a protocol roaming list. It also has an input unit that receives a request signal related to transmission of an emergency call and a control unit that transmits a channel allotment request message to a first base station in response to a signal related to transmission of the emergency call received from the input unit, receives a reorder order message, and transmits another channel allotment request message to a second base station that is searched from the protocol roaming list so as to get an allotment of a traffic channel for the emergency call.

The present invention also provides a method for emergency call connection using hand-off in a wireless communication terminal. The method comprises: receiving a request signal related to transmission of an emergency call; transmitting a channel allotment request message to a first base station in response to the request signal related to transmission of the emergency call; receiving a reorder order message from the first base station; searching a pre-stored protocol roaming list to determine a second base station for connection of the emergency call; and transmitting another channel allotment request message to the searched second base station to receive a traffic channel for the emergency call.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention. FIG. 1 shows a block diagram illustrating a wireless communication terminal for emergency call connection using hand-off according to an exemplary embodiment of the present invention.

FIG. 2 shows a flow chart illustrating a method for emergency call connection using hand-off in a wireless communication network according to an exemplary embodiment of the present invention.

FIG. 3 shows a flow chart illustrating a method for emergency call connection using hand-off in a wireless communication terminal according to another exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

FIG. 1 shows a block diagram illustrating a wireless communication terminal for emergency call connection using hand-off according to an exemplary embodiment of the present invention.

Referring to FIG. 1, the wireless communication terminal may include a wireless transceiver unit 11 for transmitting and receiving wireless signals with an external apparatus (not shown), a storage unit 12 for storing a protocol roaming list, an input unit 13, such as a key pad, for receiving a request signal related to the transmission of an emergency call, and a display unit 14, such as a liquid crystal display screen, for displaying an image in response to a control received from a control unit 15. The wireless communication terminal may also include the control unit 15. The control unit 15 transmits a origination message (that is, a message for requesting channel allotment) into a corresponding base station (not shown) in response to the request signal related to the transmission of the emergency call received from the input unit 13. If the control unit 15 receives a reorder order message (that is, a message for notifying the wireless communication terminal that a network is busy), it may transmit another origination message into another base station having a greater channel allotment possibility. The other base stations can be searched from the protocol roaming list. CODEC 16 converts signals from the wireless transceiver unit 11 to voices and outputs the voices to a sound output unit 17, such as a speaker, in response to a control received from the control unit 15. It also converts voices from a sound input unit 18, such as a microphone, to signals so as to output the signals to the control unit 15, which enables the transmission of those signals via the wireless transceiver unit 11. The sound output unit 17 outputs voices from the CODEC 16, and the sound input unit (microphone) 18 receives voices and delivers them into the CODEC 16.

Here, the control unit 15 controls the general operation of the wireless communication terminal and also provides an emergency call connection using hand-off.

If a traffic channel for the emergency call may not be allotted from the current base station in service (hereinafter, referred to as “first base station”), the control unit 15 switches from the first base station to another base station that has a greater channel allotment possibility (hereinafter, referred to as “second base station”). This may result in a hand-off and the control unit 15 may request another channel allotment request from the second base station for a faster call connection. Here, rapid hand-off to the second base station may be achieved by searching the protocol roaming list stored in the storage unit 12.

More specifically, the control unit 15 transmits an origination message to the currently connected first base station when it receives a request signal related to transmission of the emergency call through the input unit 13. For example, call transmission can be made by a button input in the fire alarm call.

If the first station fails, the control unit 15 finds a second base station having a greater channel allotment possibility by searching the protocol roaming list stored in the storage unit 12. The control unit 15 uses the information of each item such as channels stored in the protocol roaming list, such as System Identification Number (SID) and Network Identification Number (NID), to find a greater channel allotment possibility.

Then, the control unit 15 transmits the origination message to the second base station to establish an emergency call connection. When a traffic channel is allotted from the second base station, a general operation related to call connection is performed. After communication, the call connection may be released according to a request from a communication terminal.

When a traffic channel is not allotted from the second base station, the control unit 15 searches for a next second base station from the protocol roaming list, and requests another channel allotment for emergency calls from the next second base station. That is, the control unit 15 requests the channel allotment from the second base stations based on the priority order of each second base station recorded in the protocol roaming list.

The storage unit 12 may contain an operation program and a system program for the control unit 15. The operation program and the system program may be stored in a common read-only memory (ROM) region, and may be eliminated if necessary. Also, the storage unit 12 may include a random-access memory (RAM) for temporarily storing data generated during various operation programs. The storage unit 12 may store the protocol roaming list recorded by items such as channels of each base station, SID and NID.

The input unit 13 may include a plurality of input keys such as number keys, letter keys, alpha-numeric keys, menu keys function keys, or any combination thereof for performing various functions. The input unit 13 may output key data to the control unit 15 based on a user's input using the input keys or voice commands corresponding to inputs that may be made with one or more of the input keys. The input unit 13 may generate a request signal related to the transmission of emergency calls, such as a button input signal of a fire alarm call and an emergency center call.

The display unit 14, which may be a display device such as a liquid crystal display or an organic electroluminescent display, displays states of the wireless communication terminal and progress conditions of programs under the control of the control unit 15. That is, the display unit 14 displays the general states and the content inputted to the wireless communication terminal.

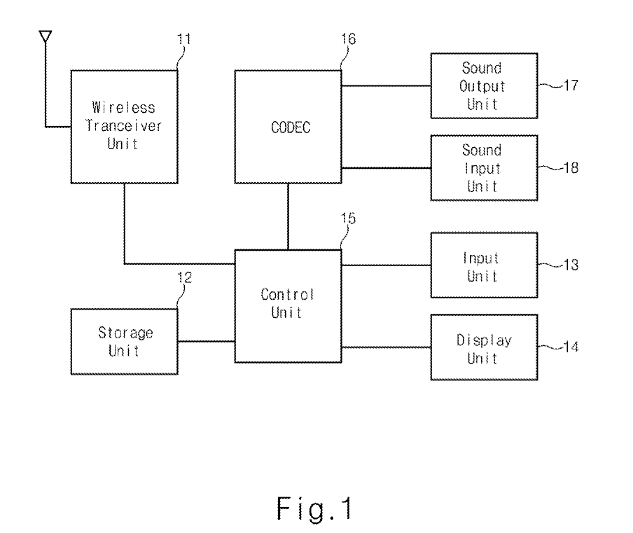

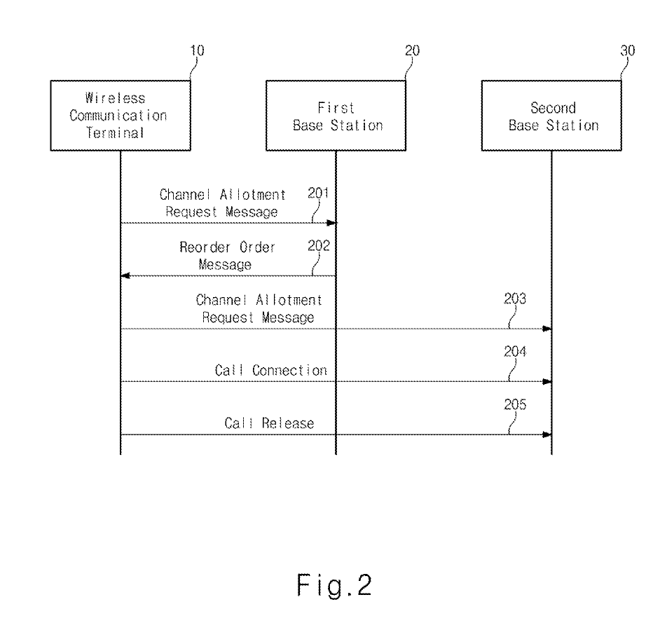

FIG. 2 shows a flow chart illustrating a method for emergency call connection using hand-off in a wireless communication network according to an exemplary embodiment of the present invention.

Here, FIG. 2 exemplifies a case in which the wireless communication terminal 10 requests channel allotment to a first base station 20 and a second base station 30.

The wireless communication terminal 10 transmits the channel allotment request message of the emergency call (i.e., fire alarm call) to the currently connected first base station 20 according to the user's request in step 201.

Then the first base station 20 may reply with a reorder order message into the wireless communication terminal 10 if there is no available channel in step 202.

The wireless communication terminal 10 may search the protocol roaming list stored therein to select the optimum second base station 30 having a greater channel allotment possibility when it receives the reorder order message from the first base station 20. The wireless communication terminal 10 may then transmit the channel allotment request message to a second base station 30 in step 203.

Thereafter, the second base station 30 may allot a traffic channel for emergency calls to the wireless communication terminal 10 to perform a general operation related to call connection in step 204 and release the call in step 205.

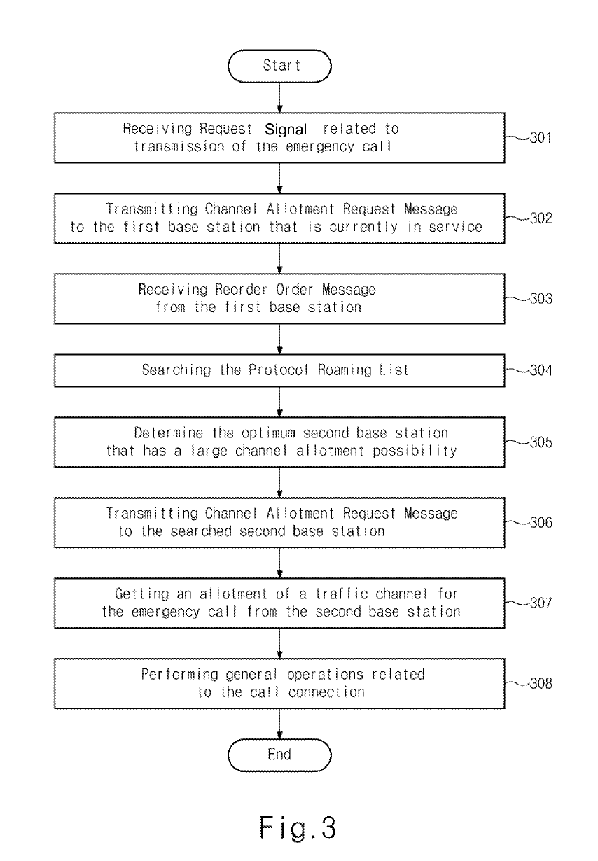

FIG. 3 shows a flow chart illustrating a method for emergency call connection using hand-off in a wireless communication terminal according to an exemplary embodiment of the present invention.

When the control unit 15 receives a signal related to transmission of emergency calls through the input unit 13 in step 301, the control unit 15 transmits the channel allotment request message to a currently connected first base station in step 302.

Then, when the reorder order message is received from the first base station in step 303, the protocol roaming list stored in the storage unit 12 is searched in step 304 and an optimum second base station having a greater channel allotment possibility is determined in step 305. That is, the control unit 15 searches the protocol roaming list including channels of each base station, SID and NID, and selects the optimum second base station based on the priority order. For example, if a “Reorder” message is received from the first base station due to the network load after a first call is transmitted to the first base station SID:2004, a base station showing the largest power is searched among the adjacent base stations except the first base station SID:2004 in the protocol roaming list, and a second call is transmitted to a second base station.

Then, the control unit 15 transmits the channel allotment request message to the second base station in step 306.

After setting a traffic channel for emergency calls from the second base station in step 307, the general call connection operation is performed in step 308.

When there is no available channel due to a load in the currently connected network (cellular network), the embodiment of the present invention does not repeat requesting the channel allotment from the same base station. Instead, the current network is handed off to another network or a base station having a greater channel allotment possibility based on a search of the protocol roaming list to allow prompt connection of emergency calls.

The above-described method may be embodied into programs and stored in storage and recording mediums, such as CD, RAM, ROM, floppy disk, hard disk, magneto-optical disk, that can be read by or executed by computers or processors. This process is not explained because it can be easily performed by a person having ordinary skill in the art.

As described above, when an emergency call cannot obtain a traffic channel, it hands off to another network or another base station having no load to get a traffic channel, thereby improving call transmission success rate of emergency calls and also reducing unnecessary battery consumption.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A wireless communication terminal, comprising:
a wireless transceiver unit transmitting and receiving a message with an external apparatus;
a storage unit storing a protocol roaming list having a list of base stations;
an input unit generating a request signal related to transmission of an emergency call; and
a control unit transmitting a first channel allotment request message to a first base station in response to the request signal generated by the input unit, and transmitting a second channel allotment request message to a second base station in the protocol roaming list when receiving a reorder order message.

2. The wireless communication terminal of claim 1, wherein the control unit transmits channel allotment request messages to base stations in the protocol roaming list based on a priority order of the base stations.

3. The wireless communication terminal of claim 1, wherein the protocol roaming list includes channels of each base station, a system identification number (SID), and a network identification number (NID).

4. A method for connecting an emergency call, comprising:
receiving an emergency call request;
transmitting a first channel allotment request message to a first base station in response to the emergency call request; and
transmitting a second channel allotment request message to a second base station in response to receiving a reorder order message from the first base station.

5. The method of claim 4, wherein the step of transmitting a second channel allotment request message to a second base station comprises:
searching a protocol roaming list to find a second base station.

6. The method of claim 5, wherein the first base station and the second base station are in the same cellular network.

7. The method of claim 5, further comprising:
searching the protocol roaming list to find an optimum base station;
transmitting another channel allotment request message to the optimum base station to receive a traffic channel for the emergency call in response to receiving a reorder order message,
wherein the optimum base station is not the first base station or the second base station.

8. The method of claim 5, wherein the protocol roaming list comprises a read-only memory or a random-access rewriteable memory storing a list of channels of each base station, SID and NID.

9. The method of claim 5, wherein the second base station has a greater channel allotment possibility in the protocol roaming list than other base stations stored in the protocol roaming list.
